(19) United States
(12) Patent Application Publication
(10) Pub. No.: US 2004/0100891 A1
(43) Pub. Date: May 27, 2004

(54) Method of startup for optical drive with an auto-balance system

(76) Inventors: Yu-Hung Sun, Taipei (TW); Chih-Hao Chang, Taipei (TW); Shih-Hung Chang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/713,285

(22) Filed: Nov. 14, 2003

(30) Foreign Application Priority Data
Nov. 19, 2002 (TW) 91133778

(51) Int. Cl. G11B 7/00

(52) U.S. Cl. 369/53.37; 369/47.39; 369/53.3

(57) ABSTRACT

A method of startup for an optical drive with an auto-balance system. When an optical disk is provided in the optical drive with the auto-balance system, a startup procedure, which includes a servo activating procedure and a system parameter adjustment procedure, is performed. Further, a rotation speed control procedure is performed cyclically according to a spindle motor RPM profile when the system parameter adjustment procedure is performed, so that data stored in the optical disk is correctly retrieved by the optical drive. Preferably, an interrupt subroutine is performed cyclically to perform the rotation speed control procedure.

### BACKGROUND OF THE INVENTION

1. Field of the Invention

The present invention relates to a method for startup of an optical drive with an auto-balance system (ABS), and particularly to a method of startup of an optical drive with an ABS with reduced startup time.

2. Description of the Related Art

Since optical media technology has rapidly improved in recent years, various kinds of optical disk drives are involved in applications as computer peripherals, and trends in optical drive design have moved toward high retrieval rate of the optical drive. The retrieval rate of the optical drive corresponds to the rotation speed of the spindle motor of the optical drive. Presently, most commercially available optical drives are made to operate with spindle motors capable of rotation speeds over 11200 RPM.

However, it is possible that the optical disk loaded into an optical drive may be eccentric. When both the disk and the spindle motor of the optical disk drive are operated at a relatively high rotation speed, centrifugal force due to imbalance of the disk increases and may lead to significant vibration.

The vibration creates instability that impairs the optical pickup head of the optical drive, so that error occurs in data readout. Further, reading data from an unstable optical disk may also result in the deterioration of performance of the optical drive. Further, noise accompanies the vibration, which is undesirable and potentially hazardous to the user. Accordingly, elimination of vibration and noise at a high rotation speed is a major concern for manufacturers of optical drives.

Conventionally, an auto-balance system (ABS) is applied to reduce vibration and noise due to the imbalance of the optical disk at high rotation speed. FIG. 1 shows an ABS of an optical drive. The ABS has a housing 12, which generally has a cylindrical shape, and a plurality of extra weights 11, such as steel balls. The housing 12 has at least one circular rail 14, which is concentric to the housing 12, to support the extra weights 11 so that the extra weights 11 roll freely in the circular rail 14. Further, the housing 12 is disposed on the spindle motor 13 in order to simultaneously rotate with the spindle.

When the spindle motor 13 rotates, the ABS rotates simultaneously with the spindle. According to rotor dynamic theory, the extra weights 11 of the ABS roll in the circular rail 14 to a relative balanced position to the housing 12 when the rotation speed of the spindle motor 13 exceeds a critical speed. Since the balanced position of the extra weights 11 corresponds to the imbalance of the eccentric disk, the ABS compensates the imbalance due to the high rotation speed of the spindle motor 13, which reduces vibration and noise.

When the optical drive is provided with the above-mentioned ABS, a spindle motor RPM profile is required to obtain the desired rotation speed control of the spindle motor. FIG. 2 is a diagram of the spindle motor RPM profile.

In FIG. 2, a plurality of set rotation speeds A, B, C and D is predetermined for startup of the optical drive. When the optical drive with ABS is activated, the rotation speed of the spindle motor 13 is increased to the first settled rotation speed A at the time T1. Then, the rotation speed of the spindle motor 13 is maintained at the rotation speed A for a standby period of T2-T1. When the spindle motor 13 is stabilized at the rotation speed A at the time T2, the rotation speed of the spindle motor 13 is increased from the rotation speed A to the second settled rotation speed B at the time T3. Similarly, the rotation speed of the spindle motor 13 is maintained at the rotation speed B for a standby period of T4-T3. When the spindle motor 13 is stabilized at the rotation speed B at the time T4, the rotation speed of the spindle motor 13 is increased from the rotation speed B to the third settled rotation speed C at the time T5. Then, the rotation speed of the spindle motor 13 is decreased to the fourth settled rotation speed D at the time T6.

By controlling the rotation speed of the spindle motor 13 under the above-mentioned spindle motor RPM profile, the extra weights 11 of the ABS roll to the balanced position in the rail 14, which lead to significantly reduced vibration and noise. That is, vibration and noise due to the high rotation speed of the spindle motor 13 can be reduced by the ABS according to the spindle motor RPM profile with a plurality of settled rotation speeds A, B, C and D. It is obvious that the spindle motor RPM profile corresponds to the vibration absorbing mechanism of the ABS. Accordingly, the desired spindle motor RPM profile can be obtained by vibration tests of the ABS.

When the user provides an optical disk and loads the optical disk into the optical drive with the above-mentioned auto-balance system, a startup procedure is performed for the optical drive to read data from the optical disk. The conventional startup procedure of the optical drive with an auto-balance system is described in detail with reference to the flowchart shown in FIG. 3.

When the startup procedure is performed (step S21), it begins with a servo activating procedure(step S22), which generally includes a rotating procedure of the spindle motor and a focusing procedure and a tracking procedure of a focus point of the optical pickup head of the optical drive. The rotating procedure of the spindle motor is activated by a spindle server for activating closed-loop control of the spindle motor. The focusing procedure of the focus point is performed by a focus server, so that the focus point is moved along a focusing direction and located at a recording surface of the optical disk for activating closed-loop focus control of the focus point. The tracking procedure of the focus point is performed simultaneously by a track server, so that the focus point is moved along a tracking direction and located at a tracking position of the optical disk for activating closed-loop track control of the focus point.

A system parameter adjustment procedure (step S23) is then performed. The system parameter adjustment procedure generally includes an optical signal adjustment procedure and an electric signal adjustment procedure for the optical disk. With the system parameter adjustment procedure performed, a plurality of desired system parameters is obtained for the optical drive.

A rotation speed control procedure for controlling a rotation speed of a spindle motor of the optical drive is then performed according to the spindle motor RPM profile (step S24). Thus, the startup procedure is accomplished (step S25) in which vibration and noise due to the high rotation speed of the spindle motor 13 is reduced by the ABS.

In the above-mentioned startup procedure, the servo activating procedure, the system parameter adjustment procedure and the rotation speed control procedure are performed consequently. However, according to the spindle motor RPM profile as shown in FIG. 2, the periods T2-T1 and T4-T3 at the rotation speed control procedure are both standby periods. Thus, the optical drive is in a standby mode and does not perform any other procedure during the two standby periods, which increases the total startup time of the optical disk.

Consequently, in the conventional optical drive with ABS, the standby periods at the rotation speed control procedure of the startup procedure neutralizes the high retrieval rate.

### SUMMARY OF THE INVENTION

In view of this, an object of the present invention is to provide a method of startup for an optical drive with an auto-balance system, in which the other procedures may be performed during the above-mentioned standby periods. Thus, the high retrieval rate is not neutralized by the standby periods, which reduces the startup time of the optical drive.

The present invention discloses a method of startup for an optical drive with an auto-balance system. According to the present invention, an optical disk is provided and loaded into the optical drive with auto-balance system. Then, a startup procedure is performed for the optical drive, in which the startup procedure includes a servo activating procedure, a system parameter adjustment procedure, and a rotation speed control procedure for controlling the rotation speed of a spindle motor of the optical drive. Further, the system parameter adjustment procedure and the rotation speed control procedure are performed alternately. Specifically, the rotation speed control procedure can be performed cyclically when the system parameter adjustment procedure is performed.

A detailed description of the present invention is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is schematic view of a conventional auto-balance system of an optical drive;

FIG. 2 is a diagram showing a conventional spindle motor RPM profile;

FIG. 3 is a flow chart showing the startup procedure of a conventional method of startup for an optical drive with an auto-balance system;

FIG. 4 is a flow chart showing the startup procedure of the method of startup for an optical drive with an auto-balance system of the present invention; and

FIG. 5 is a diagram showing the spindle motor RPM profile corresponding to the interrupt subroutine performed cyclically in the present invention.

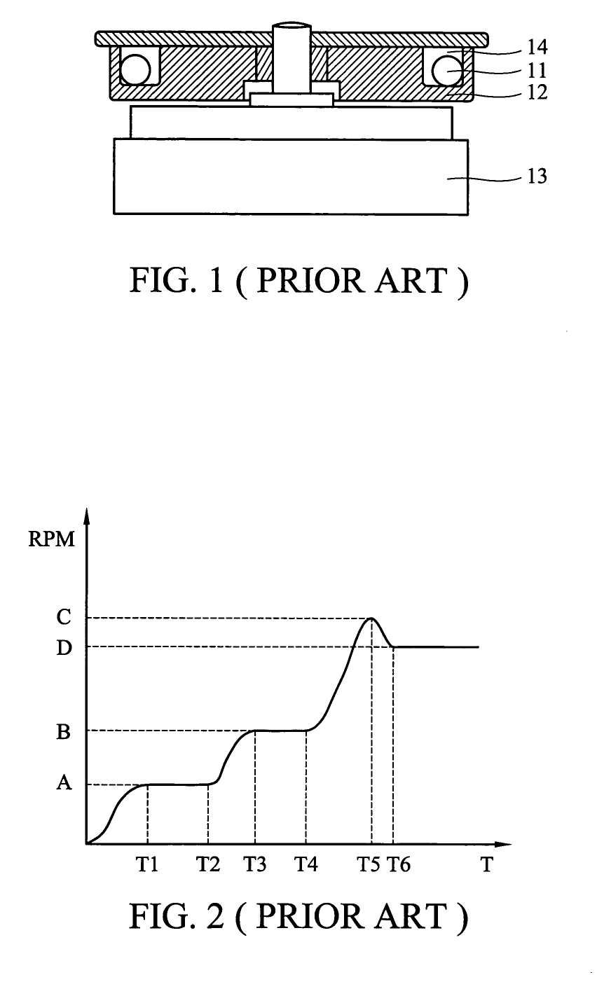

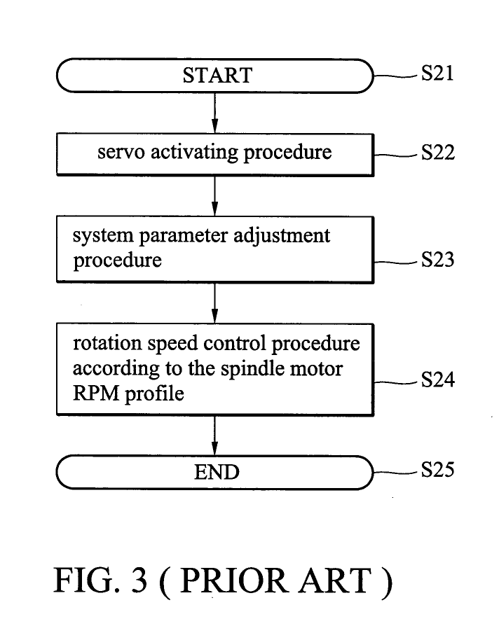

### DETAILED DESCRIPTION OF THE INVENTION

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

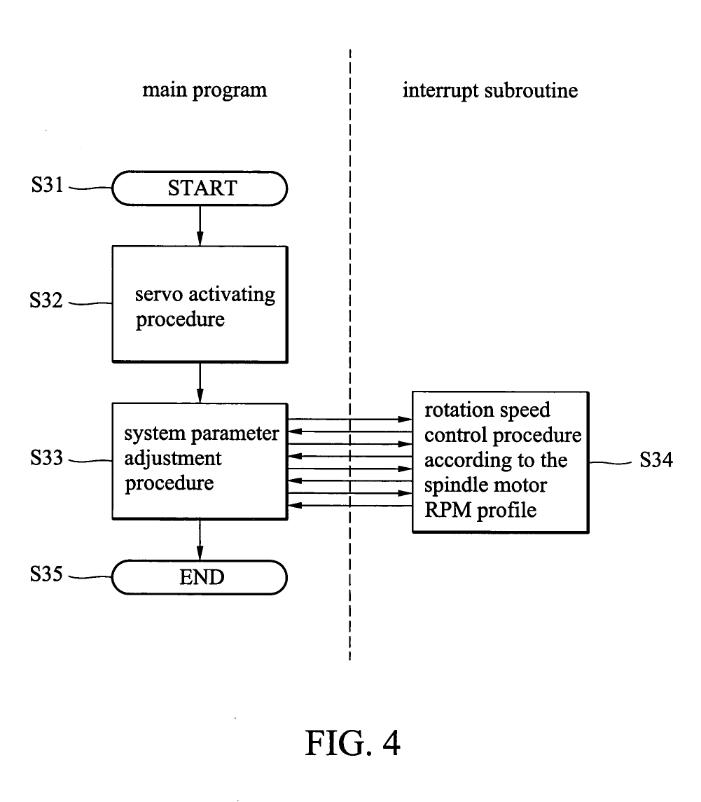

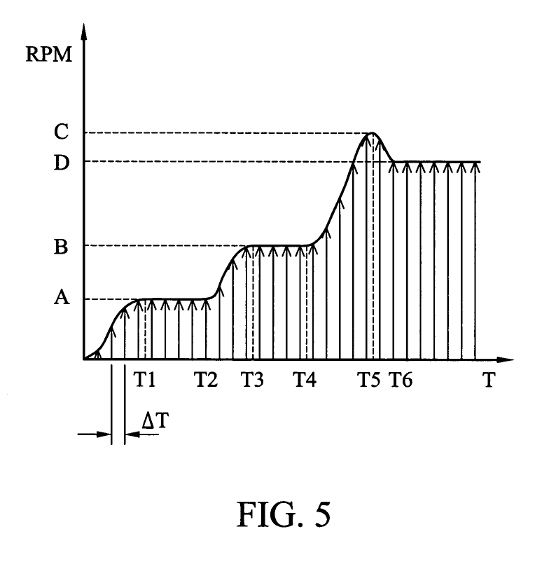

The method of startup for an optical drive with an auto-balance system of the present invention is hereinafter described with reference to FIGS. 4 and 5. FIG. 4 shows the startup procedure of the method of startup for the optical drive with the ABS of the present invention, and FIG. 5 shows an example of the spindle motor RPM profile of the present invention as a diagram, in which the spindle motor RPM profile in FIG. 5 has the same settled rotation speeds A, B, C and D with those in FIG. 2.

In the method of the present invention, an optical disk is provided and loaded into the optical drive with the auto-balance system. Then, a startup procedure is performed for the optical drive, in which the startup procedure includes a servo activating procedure, a system parameter adjustment procedure, and a rotation speed control procedure for controlling the rotation speed of a spindle motor of the optical drive.

However, in the method of the present invention, an interrupt subroutine is applied, and the rotation speed control procedure is performed by the interrupt subroutine instead of the main program for the optical drive. Since the interrupt subroutine can be performed cyclically by the main program, the system parameter adjustment procedure and the rotation speed control procedure can be performed alternately.

When the user provides an optical disk and loads the optical disk into the optical drive with the auto-balance system, the startup procedure of the present invention is performed (step S31). The startup procedure begins with a servo activating procedure (step S32) performed by the main program.

The servo activating procedure generally includes a rotating procedure of the spindle motor and a focusing procedure and a tracking procedure of a focus point of the optical pickup head of the optical drive. The rotating procedure of the spindle motor is activated by a spindle server for activating closed-loop control of the spindle motor. The focusing procedure of the focus point is performed by a focus server, so that the focus point is moved along a focusing direction and located at a recording surface of the optical disk for activating closed-loop focus control of the focus point. Simultaneously, the tracking procedure of the focus point is performed by a track server, so that the focus point is moved along a tracking direction and located at a tracking position of the optical disk for activating closed-loop track control of the focus point.

Then, a system parameter adjustment procedure (step S33) is performed by the main program. The system parameter adjustment procedure generally includes an optical signal adjustment procedure and an electric signal adjustment procedure for the optical disk.

While performing the system parameter adjustment procedure in step S33, the main program calls for the interrupt subroutine cyclically with a cycle time of ΔT, as shown in FIG. 5. When the interrupt subroutine is performed, the rotation speed control procedure is performed (step S34) according to the spindle motor RPM profile in FIG. 5. Since the interrupt subroutine is performed cyclically with the cycle time of ΔT, the rotation speed control procedure is also performed cyclically with the cycle time of ΔT.

In each cycle of the interrupt subroutine, the rotation speed control procedure maintains the rotation speed of the spindle motor of the optical drive according to the corresponding curve portion of the spindle motor RPM profile, so that vibration and noise of the spindle motor 13 is reduced by the ABS. When the rotation speed performance is under control of the corresponding curve portion of the spindle motor RPM profile, the main program resumes control, and the system parameter adjustment procedure in step S33 is performed.

Thus, the system parameter adjustment procedure and the rotation speed control procedure are performed alternately, and the rotation speed control procedure (step S34) is performed cyclically during the system parameter adjustment procedure (step S33) is performed.

Consequently, when the startup procedure is complete (step S35), vibration, and noise due to the high rotation speed of the spindle motor 13 is reduced by the ABS.

It should be noted that the servo activating procedure (step S32) and the system parameter adjustment procedure (step S33) are performed by the main program, and the rotation speed control procedure (step S34) is performed by the interrupt subroutine.

In the method of the present invention, the main program and the interrupt subroutine resume control alternately. As a result, when the rotation speed control procedure is performed according to the spindle motor RPM profile in the standby periods T2-T1 and T4-T3, the main program resumes control and performs the system parameter adjustment procedure when the rotation speed performance is under control of the corresponding curve portion of the spindle motor RPM profile. Thus, the system parameter adjustment procedure is performed periodically in these two standby periods, which enables the optical drive to effectively utilize the system resource and to shorten the standby periods.

With the method of the present invention, the optical drive with the ABS can operate with reduced vibration and noise and startup time is reduced. Consequently, the optical drive with ABS starts rapidly, and operational stability is retained.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of startup for an optical drive with an auto-balance system, comprising the steps of:
providing an optical disk and loading the optical disk into the optical drive with the auto-balance system; and
performing a startup procedure for the optical drive, the startup procedure comprising a servo activating procedure, a system parameter adjustment procedure, and a rotation speed control procedure for controlling the rotation speed of a spindle motor of the optical drive;
wherein the system parameter adjustment procedure and the rotation speed control procedure are performed alternately.

2. The method of startup for an optical drive with an auto-balance system according to claim 1, wherein the servo activating procedure further comprises:
a rotating procedure of the spindle motor by a spindle server for activating closed-loop control of the spindle motor;
a focusing procedure of a focus point of the optical drive at a recording surface of the optical disk along a focusing direction by a focus server for activating closed-loop focus control of the focus point; and
a tracking procedure of the focus point at a tracking position of the optical disk along a tracking direction by a track server for activating closed-loop track control of the focus point.

3. The method of startup for an optical drive with an auto-balance system according to claim 1, wherein the system parameter adjustment procedure is comprised of an optical signal adjustment procedure and an electric signal adjustment procedure for the optical disk.

4. The method of startup for an optical drive with an auto-balance system according to claim 1, whereat the rotation speed control procedure is performed cyclically when the system parameter adjustment procedure is performed with a cycle time of ΔT.

5. The method of startup for an optical drive with an auto-balance system according to claim 4, whereat the rotation speed control procedure is performed for maintaining the rotation speed of the spindle motor according to a corresponding portion of a spindle motor RPM profile.

6. The method of startup for an optical drive with an auto-balance system according to claim 4, wherein an interrupt subroutine is performed cyclically with the cycle time of ΔT to perform the rotation speed control procedure.

7. A method of startup for an optical drive with an auto-balance system, comprising the steps of:
providing an optical disk and loading the optical disk into the optical drive with the auto-balance system; and
performing a startup procedure for the optical drive, the startup procedure comprising a servo activating procedure, and a system parameter adjustment procedure;
wherein a rotation speed control procedure for controlling a rotation speed of a spindle motor of the optical drive is performed cyclically when the system parameter adjustment procedure is performed.

8. The method of startup for an optical drive with an auto-balance system according to claim 7, wherein the servo activating procedure further comprises:
a rotating procedure of the spindle motor by a spindle server for activating closed-loop control of the spindle motor;
a focusing procedure of a focus point of the optical drive at a recording surface of the optical disk along a focusing direction by a focus server for activating closed-loop focus control of the focus point; and
a tracking procedure of the focus point at a tracking position of the optical disk along a tracking direction by a track server for activating closed-loop track control of the focus point.

9. The method of startup for an optical drive with an auto-balance system according to claim 7, wherein the system parameter adjustment procedure is comprised of an optical signal adjustment procedure and an electric signal adjustment procedure for the optical disk.

10. The method of startup for an optical drive with an auto-balance system according to claim 7, wherein an interrupt subroutine is performed cyclically to perform the rotation speed control procedure.

11. The method of startup for an optical drive with an auto-balance system according to claim 10, wherein the interrupt subroutine is performed for maintaining the rotation speed of the spindle motor according to a corresponding portion of a spindle motor RPM profile.

12. The method of startup for an optical drive with an auto-balance system according to claim 7, wherein the servo activating procedure and the system parameter adjustment procedure are performed by a main program.
